(19) United States
(12) Patent Application Publication
(10) Pub. No.: US 2025/0252722 A1
(43) Pub. Date: Aug. 7, 2025

(54) MULTI-TASK LARGE MODEL TRAINING METHOD AND APPARATUS

(71) Applicant: Alipay (Hangzhou) Information Technology Co., Ltd., Hangzhou (CN)

(72) Inventors: Haowen WANG, Hangzhou (CN); Tao SUN, Hangzhou (CN)

(21) Appl. No.: 19/041,772

(22) Filed: Jan. 30, 2025

(30) Foreign Application Priority Data
Feb. 2, 2024 (CN) 202410153749.3

(51) Int. Cl. G06V 10/82; G06F 40/295; G06F 40/30; G06F 40/40; G06V 10/26; G06V 10/764; G06V 10/774

(52) U.S. Cl. CPC G06V 10/82; G06F 40/40; G06V 10/774; G06F 40/295; G06F 40/30; G06V 10/26; G06V 10/764; G06V 2201/07

(57) ABSTRACT

Embodiments of this specification relate to a multi-task large model training method and apparatus. The method includes: obtaining a first embedding vector corresponding to a first sample, where the first sample has a first task type; separately inputting the first embedding vector into the target network layer to perform target processing, and inputting the first embedding vector into the bypass task network to perform bypass processing, where the bypass processing includes: separately processing the first embedding vector by using the several universal adapters and a first dedicated adapter corresponding to the first task type, and performing weighted summation on processing results of the adapters, to obtain a second embedding vector; determining a prediction result based on the second embedding vector and a third embedding vector output through the target processing; and updating the bypass task network based on a loss corresponding to the prediction result.

### TECHNICAL FIELD

One or more embodiments of this specification relate to the artificial intelligence field, and in particular, to a multi-task large model training method and apparatus.

### BACKGROUND

With improvement of computing power of computer hardware and improvement of availability of a large-scale data set, a large model with a large-scale parameter and a stronger capability has come into people's view. A large model is usually pre-trained based on the large-scale data set, and then is fine-tuned by using a corresponding small-scale data set based on a specific downstream task, to adapt to the specific task.

If the large model is expected to be simultaneously applied to tasks of a plurality of task types, the large model needs to be fine-tuned separately or simultaneously based on data sets of the plurality of task types. However, task signals of different task types may interfere with each other, resulting in a “seesaw effect”. In other words, when a capability of the large model for a task of a specific task type is enhanced, a capability of the large model for another task type is reduced. In addition, because of heterogeneity between a data set of a downstream task and a data set used during pre-training, if fine-tuning is directly performed, it is difficult to achieve a very good effect, and even a negative transfer may occur. That is, a fine-tuned large model is less effective than a large model existing before fine-tuning. Therefore, a better method needs to be used to fine-tune the large model in a multi-task scenario, so that the fine-tuned large model can be simultaneously applied to the tasks of the plurality of task types.

### SUMMARY

One or more embodiments of this specification describe a multi-task large model training method and apparatus, to enhance a generalization effect of a trained large model, so that the large model is simultaneously applicable to a plurality of task scenarios.

According to a first aspect, a multi-task large model training method is provided. A large model includes a trained target network layer and a to-be-trained bypass task network, the bypass task network includes several universal adapters and a plurality of dedicated adapters that respectively correspond to a plurality of preset task types, and has weight parameters corresponding to adapters, and the method includes:
obtaining a first embedding vector corresponding to a first sample, where the first sample includes at least one of image data and text data, and has a first task type, and the first task type belongs to the plurality of preset task types;
separately inputting the first embedding vector into the target network layer to perform target processing, and inputting the first embedding vector into the bypass task network to perform bypass processing, where the bypass processing includes: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector;
determining an output vector based on the second embedding vector and a third embedding vector output through the target processing, and determining a prediction result based on the output vector; and
updating the bypass task network based on a loss corresponding to the prediction result.

In a possible implementation, upon determining that the first sample is image data, the task type includes at least image classification, target detection, image segmentation, and image description; and
upon determining that the first sample is text data, the task type includes at least text classification, named entity recognition, text summarization, text question answering, and text emotion recognition.

In a possible implementation, the first sample includes image data and text data, and the plurality of preset task types are tasks associated with an image-text association.

In a possible implementation, the large model includes an image encoder, a bridge network, and a natural language processing network; the bridge network is connected between the image encoder and the natural language processing network, and is configured to convert an encoding result of the image encoder into text representation space; the target network layer belongs to the bridge network; and the first embedding vector corresponds to the image data.

In a possible implementation, the large model includes an image encoder, a bridge network, and a natural language processing network; the bridge network is connected between the image encoder and the natural language processing network, and is configured to convert an encoding result of the image encoder into text representation space; the target network layer includes a first target layer and a second target layer; the bypass task network includes a first task network as a bypass of the first target layer and a second task network as a bypass of the second target layer; the first target layer belongs to the bridge network; and the second target layer belongs to the natural language processing network.

In a possible implementation, the weight parameters includes a first parameter matrix and a second parameter set, a quantity of rows and a quantity of columns of the first parameter matrix respectively correspond to a quantity of preset task types and a quantity of universal adapters, a first weight parameter at any location indicates a weight of a corresponding universal adapter in a corresponding task type, and the second parameter set includes at least a second weight parameter corresponding to each of the plurality of dedicated adapters.

In a possible implementation, the dedicated adapter includes a plurality of sub-adapters, and a second weight parameter corresponding to any dedicated adapter includes a plurality of sub-weight parameters corresponding to the plurality of sub-adapters.

In a possible implementation, performing weighted summation on processing results of the adapters based on the weight parameters, to obtain a second embedding vector includes:
obtaining a first weight parameter of each universal adapter in the first task type from the first parameter matrix, and obtaining a second weight parameter corresponding to the first dedicated adapter from the second parameter set; and
performing weighted summation on each first result of performing the first embedding vector by each universal adapter and a second result of processing the first embedding vector by the first dedicated adapter, to obtain the second embedding vector, where a weight factor of each first result is determined based on the first weight parameter, and a weight factor of the second result is determined based on the second weight parameter.

In a possible implementation, the weight factor of each first result is determined in the following method:
inputting the first weight parameter of each universal adapter in the first task type in the first parameter matrix into a Gumbel-Sigmoid function, and inputting an output result into a softmax layer, to obtain the weight factor of each first result.

In a possible implementation, the adapters include at least one of the following: a LoRA adapter, an AdaLoRA adapter, and an (IA) 3 adapter.

In a possible implementation, the large model is a model based on a transformer architecture, and the target network layer is one of the following: a query layer, a key layer, a value layer, an output layer, and an MLP layer.

According to a second aspect, a multi-task large model training apparatus is provided. A large model includes a trained target network layer and a to-be-trained bypass task network, the bypass task network includes several universal adapters and a plurality of dedicated adapters that respectively correspond to a plurality of preset task types, and has weight parameters corresponding to adapters, and the apparatus includes:
an obtaining unit, configured to obtain a first embedding vector corresponding to a first sample, where the first sample includes at least one of image data and text data, and has a first task type, and the first task type belongs to the plurality of preset task types;
an embedding vector processing unit, configured to: separately input the first embedding vector into the target network layer to perform target processing, and input the first embedding vector into the bypass task network to perform bypass processing, where the bypass processing includes: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector;
a prediction result determining unit, configured to: determine an output vector based on the second embedding vector and a third embedding vector output through the target processing, and determine a prediction result based on the output vector; and
a bypass network updating unit, configured to update the bypass task network based on a loss corresponding to the prediction result.

According to a third aspect, a computer-readable storage medium is provided. The computer-readable storage medium stores a computer program, and when the computer program is executed on a computer, the computer is enabled to perform the method according to the first aspect.

According to a fourth aspect, a computing device is provided, including a memory and a processor. The memory stores executable code, and when executing the executable code, the processor implements the method according to the first aspect.

According to the multi-task large model training method and apparatus provided in the embodiments of this specification, a network layer that needs to be fine-tuned in the large model is fine-tuned by using the bypass task network, so that the large model can be fine-tuned without changing an original parameter of the large model, to reduce an operation scale required for fine-tuning the large model. In addition, adapters in the bypass task network are explicitly classified into a universal adapter applicable to all tasks and a dedicated adapter applicable to a specific task, and then parameters of these adapters and weights used when weighted summation is performed on output results of a plurality of adapters are separately trained. According to the above-mentioned solution, an impact of a seesaw effect and a negative transfer can be reduced, and a generalization effect of a trained large model is enhanced, so that the large model is simultaneously applicable to a plurality of task scenarios.

### BRIEF DESCRIPTION OF DRAWINGS

To describe technical solutions in a plurality of embodiments disclosed in this specification more clearly, the following briefly describes the accompanying drawings needed for describing the embodiments. Clearly, the accompanying drawings in the following descriptions show merely the plurality of embodiments disclosed in this specification, and a person of ordinary skill in the art can still derive other drawings from these accompanying drawings without creative efforts.

FIG. 1 is a schematic diagram of an architecture of a multi-task large model training method according to an embodiment;

FIG. 2 is a flowchart of a multi-task large model training method according to an embodiment;

FIG. 3 is a schematic diagram of an architecture of a large model according to an embodiment;

FIG. 4 is a schematic diagram of fine-tuning a network layer in a natural language network according to an embodiment;

FIG. 5 is a schematic diagram of fine-tuning a network layer in a bridge network according to an embodiment;

FIG. 6 is a schematic diagram of simultaneously fine-tuning a network layer in a bridge network and a network layer in a natural language network according to an embodiment; and

FIG. 7 is a schematic block diagram of a multi-task large model training apparatus according to an embodiment.

### DESCRIPTION OF EMBODIMENTS

The following describes the solutions provided in this specification with reference to the accompanying drawings.

As described above, if a large model is directly fine-tuned in a multi-task scenario, a seesaw effect is created, and a negative transfer may occur, so that a fine-tuned large model is less effective than a large model existing before fine-tuning. Therefore, a solution needs to be used, so that the fine-tuned large model can be simultaneously applied to tasks of a plurality of task types.

Currently, there are a plurality of types of machine learning tasks in the artificial intelligence field. For example, for text content, a task can be performing classification on the text content, named entity recognition, text-based summary generation, text question answering, text emotion recognition, etc.; and for image content, a task can be image classification, target detection, image content segmentation, image description, etc. In addition, a plurality of tasks can be executed for same input content. For example, for an image that includes a cat, target detection, image content segmentation, and image description can be simultaneously performed: detecting a location of the cat in the image, obtaining a part that includes the cat in the image, and generating an image description: “An orange cat is sleeping”.

According to research and observation of an inventor, different types of tasks are not completely independent, and potential knowledge that can be used for mutual reference and that can be transferred exists between a plurality of task types. In addition, each task has unique content different from that of another task. Therefore, common parts and unique parts of different task types can be effectively used based on the above-mentioned features.

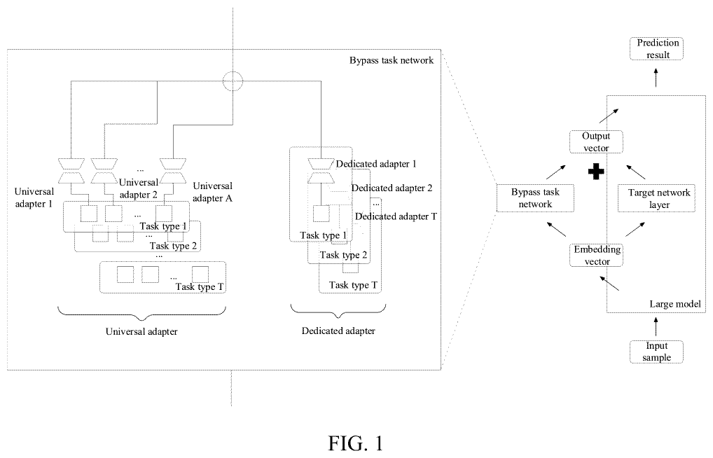

Based on the above-mentioned analysis, an embodiment of this specification provides a bypass fine-tuning manner applicable to a plurality of tasks. Instead of directly adjusting a pre-trained network layer, a trainable bypass task network is disposed on a bypass of the network layer, and the bypass task network is explicitly classified into a task universal network and a task dedicated network. FIG. 1 is a schematic diagram of an architecture of a multi-task large model training method according to an embodiment. In an example in FIG. 1, a large model that needs to be fine-tuned is on a right side, and has a plurality of network layers, including a target network layer to be fine-tuned. A bypass task network is disposed on a bypass of the target network layer. Therefore, in a forward propagation process, the bypass task network and the target network layer simultaneously receive an input vector from an upper-layer network of the large model, separately process the input vector, perform summation on respective output results, obtain a result vector output by the layer, and use an output vector as an input into a lower-layer network of the large model. In a fine-tuning process, an original weight parameter in the target network layer is kept unchanged (this process can also be referred to as “freezing”), and only a weight parameter in the bypass task network is adjusted, to reduce a computing scale during fine-tuning.

The bypass task network includes one or more adapters, and a plurality of adapters are independent of each other. The adapter has an adjustable parameter. The adapter receives an input embedding vector, processes the embedding vector, and outputs a corresponding embedding vector. The adapter can be, for example, implemented as a neural network. The adapters in the bypass task network are explicitly classified into a universal adapter applicable to all task types and a dedicated adapter applicable to a single task. When a total quantity of task types is T, A universal adapters and T dedicated adapters can be disposed. When a task of a task type t is executed for the embedding vector, all the A universal adapters are used, and a dedicated adapter t corresponding to the task type t is used. Specifically, an embedding vector (represented by a small square in FIG. 1) corresponding to an input sample is separately input into the A universal adapters and the dedicated adapter t for separate processing, weighted summation is performed on outputs of the A+1 adapters, and a sum is used as a result vector of the bypass task network for the embedding vector for output.

During training (fine-tuning), a loss between a prediction result of a large model obtained based on the above-mentioned procedure and a label of the input sample is propagated backward, and parameters in all the adapters in the bypass task network and weights that correspond to all the adapters and that are used during weighted summation are adjusted. During reasoning, a reasoning result of the input sample is directly obtained based on the above-mentioned procedure.

It can be understood that, because the target network layer can be any layer in the large model, the bypass task network described in this embodiment of this specification can be configured to fine-tune any network layer in the large model. Further, a plurality of target network layers in the large model can be further selected, and respective bypass task networks are respectively disposed next to the plurality of target network layers, to simultaneously fine-tune the plurality of target network layers in the large model, and achieve a better fine-tuning effect.

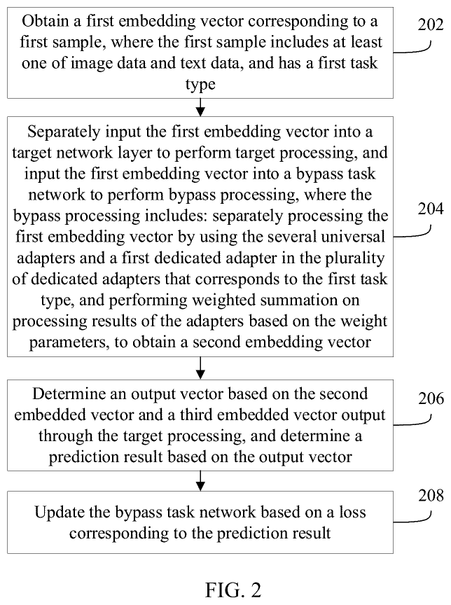

With reference to a specific embodiment, the following describes specific implementation steps of the above-mentioned multi-task large model training method. FIG. 2 is a flowchart of a multi-task large model training method according to an embodiment. A large model includes a trained target network layer and a to-be-trained bypass task network, the bypass task network includes several universal adapters and a plurality of dedicated adapters that respectively correspond to a plurality of preset task types, and has weight parameters corresponding to adapters. The method can be performed by any platform, server, device cluster, etc. with a computing and processing capability. As shown in FIG. 2, the method includes at least the following steps. Step 202: Obtain a first embedding vector corresponding to a first sample, where the first sample includes at least one of image data and text data, and has a first task type, and the first task type belongs to the plurality of preset task types. Step 204: Separately input the first embedding vector into the target network layer to perform target processing, and input the first embedding vector into the bypass task network to perform bypass processing, where the bypass processing includes: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector. Step 206: Determine an output vector based on the second embedding vector and a third embedding vector output through the target processing, and determine a prediction result based on the output vector. Step 208: Update the bypass task network based on a loss corresponding to the prediction result.

First, the universal adapter, the dedicated adapter, and the weight parameter are described. If a total quantity of task types is T, A universal adapters denoted as {ϕ₁, ϕ₂, . . . ϕ_{A}} and T dedicated adapters denoted as {ϕ¹, ϕ², . . . ϕ^{T}} can be disposed, and all the dedicated adapters correspond to all the task types. Any adapter ϕ can receive an input embedding vector x, and output a processed vector ϕ(x).

A plurality of types of adapters can be used as the adapters used in this embodiment of this specification. For example, a low-rank adaptation (LoRA) adapter, an adaptive low-rank adaptation (AdaLoRA) adapter, an adapter ((IA)³ adapter) proposed in a paper Few-Shot Parameter-Efficient Fine-Tuning is Better and Cheaper than In-Context Learning can be used. This is not limited here.

The weight parameter can include a first parameter matrix W_{A} and a second parameter set, a quantity of rows and a quantity of columns of the first parameter matrix W_{A} respectively correspond to a quantity T of preset task types and a quantity A of universal adapters. That is, the first parameter matrix is a T*A matrix, and a first weight parameter wᵢ^{t} at any location in the matrix indicates a weight of a corresponding universal adapter t in a corresponding task type i.

In an embodiment, the first parameter matrix W_{A} can be recorded in a form shown in Formula (1):

$${W}_{A} = [ \begin{matrix}{w}_{1}^{1} & {w}_{2}^{1} & … & {w}_{A}^{1} \\ {w}_{1}^{2} & {w}_{2}^{2} & … & {w}_{A}^{2} \\ … & … & … & … \\ {w}_{1}^{T} & {w}_{2}^{T} & … & {w}_{A}^{T}\end{matrix} ] \qquad ( 1 )$$

Each weight parameter value in the first parameter matrix W_{A} can be initialized by performing uniform sampling within (0, 1).

The second parameter set includes at least a second weight parameter w^{j} corresponding to each of the plurality of dedicated adapters. In an embodiment, the second parameter set can be implemented as a second parameter matrix W_{B}; the second parameter matrix W_{B} is a diagonal matrix; a size of the second parameter matrix is the same as the quantity T of preset task types, that is, the second parameter matrix is a T*T matrix; and a second weight parameter w^{j} at any diagonal location of the second parameter matrix indicates a weight of a corresponding dedicated adapter j.

In an embodiment, the second parameter matrix W_{B} can be recorded in a form shown in Formula (2):

$${W}_{B} = [ \begin{matrix}{w}^{1} & 0 & … & 0 \\ 0 & {w}^{2} & … & 0 \\ … & … & … & … \\ 0 & 0 & … & {w}^{T}\end{matrix} ] \qquad ( 2 )$$

During initialization, each weight parameter value in the second parameter set can be initialized to 1.

The second parameter matrix shown in Formula (2) is a diagonal matrix, and only elements on a diagonal line are not 0. In an embodiment, the second parameter set can be represented as an array including T diagonal elements.

Based on this, in an embodiment, the first parameter matrix W_{A} and the second parameter matrix W_{B} are horizontally concatenated, to obtain a weight parameter W in a form of a matrix, as shown in Formula (3):

$$W = [ {W}_{A} \vert {W}_{B} ] = [ \begin{matrix}{w}_{1}^{1} & {w}_{2}^{1} & … & {w}_{A}^{1} & {w}^{1} & 0 & … & 0 \\ {w}_{1}^{2} & {w}_{2}^{2} & … & {w}_{A}^{2} & 0 & {w}^{2} & … & 0 \\ … & … & … & … & … & … & … & … \\ {w}_{1}^{T} & {w}_{2}^{T} & … & {w}_{A}^{T} & 0 & 0 & … & {w}^{T}\end{matrix} ] \qquad ( 3 )$$

The following describes a specific execution process of the above-mentioned steps based on the above-mentioned marks.

First, in step 202, a first embedding vector x^{t} corresponding to a first sample is obtained. The first sample includes at least one of image data and text data, and has a first task type t, and the first task type t belongs to the plurality of preset task types.

The first embedding vector x^{t} can be an output vector of an upper layer of the target network layer in the large model after the first sample is input into the large model. A total quantity of preset task types is T, and the first task type t is one of the T task types.

In an embodiment, the large model has a first network before the target network layer; and the first embedding vector x^{t} is determined in the following method: inputting the first sample into the first network, to obtain the first embedding vector x^{t}.

In an embodiment, when the first sample is image data, the task type includes at least image classification, target detection, image segmentation, and image description; and when the first sample is text data, the task type includes at least text classification, named entity recognition, text summarization, text question answering, and text emotion recognition.

Then, in step 204, the first embedding vector x^{t} is separately input into the target network layer to perform target processing, and input into the bypass task network to perform bypass processing. The bypass processing includes: separately processing the first embedding vector x^{t} by using the several universal adapters {ϕ₁, ϕ₂, . . . ϕ_{A}} and a first dedicated adapter ϕ^{t} in the plurality of dedicated adapters that corresponds to the first task type t, and performing weighted summation on processing results of the adapters based on the weight parameters, to obtain a second embedding vector z₂.

In an embodiment, the performing weighted summation on processing results of the adapters based on the weight parameters, to obtain a second embedding vector z₂ in step 204 specifically includes: obtaining a first weight parameter [w₁^{t} w₂^{t} . . . w_{A}^{t}] of each universal adapter {ϕ₁, ϕ₂, . . . ϕ_{A}} in the first task type t from the first parameter matrix W_{A}, and obtaining a second weight parameter w^{t} corresponding to the first dedicated adapter ϕ^{t} from the second parameter set; and performing weighted summation on each first result of performing the first embedding vector x^{t} by each universal adapter and a second result of processing the first embedding vector x^{t} by the first dedicated adapter ϕ^{t}, to obtain the second embedding vector z₂. A weight factor of each first result is determined based on the first weight parameter, and a weight factor of the second result is determined based on the second weight parameter.

In an implementation, the weight parameter is directly used as a weight factor that is of an output result of each adapter and that is used during weighted summation. In this case, a method for computing the second embedding vector z₂ can be shown in Formula (4):

$${z}_{2} = {\sum }_{i = 1}^{A} {w}_{i}^{t} {ϕ}_{i} ( {x}^{t} ) + {w}^{t} {ϕ}^{t} ( {x}^{t} ) \qquad ( 4 )$$

In another implementation, an original weight parameter is further processed, and is used as a weight factor used during weighted summation. In a more specific embodiment, the weight factor of each first result is determined in the following method:
inputting the first weight parameter [w₁^{t} w₂^{t} . . . w_{A}^{t}] of each universal adapter {ϕ₁, ϕ₂, . . . ϕ_{A}} in the first task type t in the first parameter matrix W_{A} into a Gumbel-Sigmoid function, and inputting an output result into a softmax layer, to obtain the weight factor [ [symbol] [symbol] . . . [symbol] ] of each first result. In this embodiment, a method for computing the second embedding vector z₂ can be shown in Formula (5):

$${z}_{2} = {\sum }_{i = 1}^{A} {ϕ}_{i} ( {x}^{t} ) + {w}^{t} {ϕ}^{t} ( {x}^{t} ) \qquad ( 5 )$$

In some possible implementations, any dedicated adapter includes a plurality of sub-adapters, and the second weight parameter corresponding to the any dedicated adapter includes a plurality of sub-weight parameters corresponding to the plurality of sub-adapters. Weighted summation is performed on output results of the plurality of sub-adapters based on respective sub-weight parameters, and a sum is used as an output for a dedicated adapter of this task type.

After the second embedding vector z₂ output by the bypass task network is obtained, next, in step 206, an output vector zₒᵤₜ is determined based on the second embedding vector z₂ and a third embedding vector z₃ output through the target processing, and a prediction result is determined based on the output vector zₒᵤₜ.

In an embodiment, the large model has a second network after the target network layer. In this case, step 206 specifically includes: determining the output vector zₒᵤₜ based on a fusion result, for example, a summation result, of the second embedding vector z₂ and the third embedding vector z₃, that is, zₒᵤₜ=z₂+z₃; and inputting the output vector zₒᵤₜ to the second network, to obtain the prediction result.

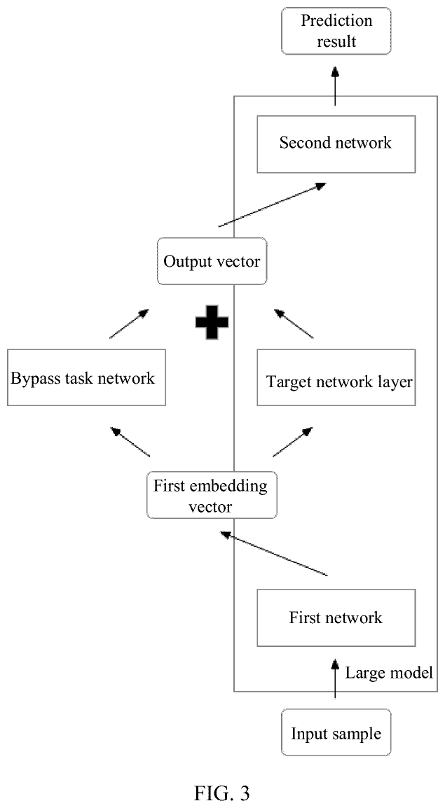

A procedure of determining the prediction result based on an input sample by combining the large model and the bypass task network can be shown in FIG. 3. FIG. 3 is a schematic diagram of an architecture of a large model according to an embodiment. In FIG. 3, the large model includes the first network, the target network layer, and the second network in a sequence of a data flow direction. An input sample whose task type is t is input into the first network, to obtain the first embedding vector x^{t}. The first embedding vector x^{t} is separately input into the target network layer and the bypass task network, and the output vector zₒᵤₜ obtained in the above-mentioned method is input into the second network, to obtain a prediction result for the input sample.

Finally, in step 208, the bypass task network is updated based on a loss corresponding to the prediction result.

In some possible implementations, the large model is a model based on a transformer architecture, and the target network layer is one of the following: a query layer, a key layer, a value layer, an output layer, and a multilayer perceptron (MLP) layer.

A process of fine-tuning, by using the bypass task network, the target network layer that needs to be fine-tuned in the large model is described in step 202 to step 208. A plurality of input samples of different task types are used to separately perform a plurality of rounds of training on the bypass task network in the fine-tuning method described in step 202 to step 208, to obtain a trained large model that is simultaneously applicable to the plurality of task types.

The following describes a plurality of specific embodiments with reference to different types of input samples.

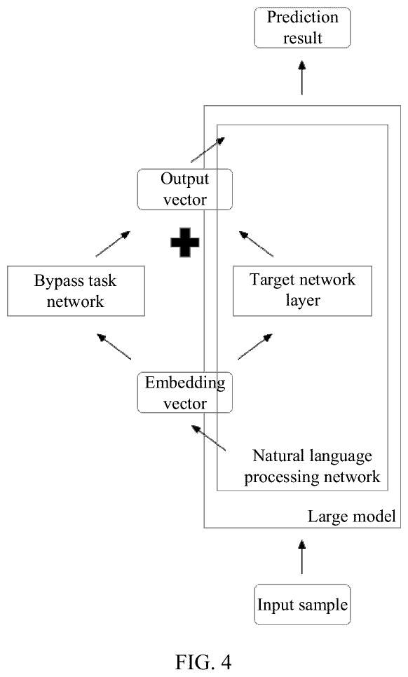

In an embodiment, the first sample includes text data, and the plurality of preset task types are text-related tasks. In this case, the large model includes a natural language processing network for processing text content, the target network layer belongs to the natural language processing network, and the first embedding vector corresponds to the text data. The bypass task network is configured to fine-tune a network layer in the natural language processing network. A model architecture in this embodiment can be shown in FIG. 4.

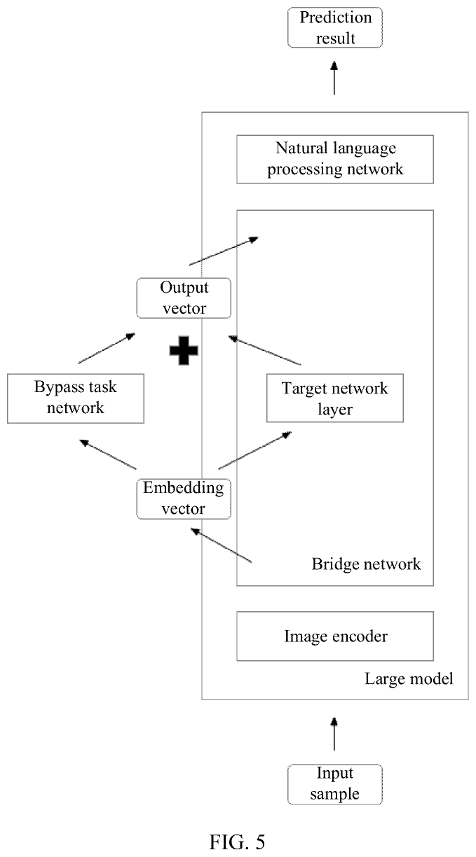

In another embodiment, the large model is a multimodal large model applicable to image and text processing. The first sample includes image data and text data, and the plurality of preset task types are tasks associated with an image-text association, for example, image-to-text generation, text-to-image generation, or text-image matching. In this case, the large model includes an image encoder, a bridge network, and a natural language processing network; and the bridge network is connected between the image encoder and the natural language processing network, and is configured to convert an encoding result of the image encoder into text representation space. In a specific example, the target network layer can belong to the bridge network; and the first embedding vector corresponds to the image data. The bypass task network is configured to fine-tune a network layer in the bridge network. A model architecture in this embodiment can be shown in FIG. 5.

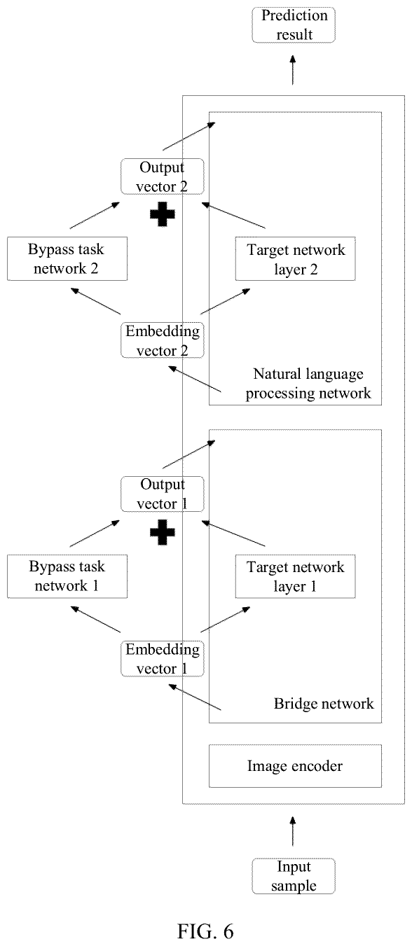

In still another embodiment, the first sample includes image data and text data, and the plurality of preset task types are tasks associated with an image-text association. The large model includes an image encoder, a bridge network, and a natural language processing network; and the bridge network is connected between the image encoder and the natural language processing network, and is configured to convert an encoding result of the image encoder into text representation space. The target network layer includes a first target layer and a second target layer; and the bypass task network includes a first task network as a bypass of the first target layer and a second task network as a bypass of the second target layer. The first target layer belongs to the bridge network; and the second target layer belongs to the natural language processing network. The two bypass task networks are respectively configured to fine-tune a network layer in the bridge network and a network layer in the natural language processing network. A model architecture in this embodiment can be shown in FIG. 6.

In yet another embodiment, a plurality of bypass task networks can be disposed in different network parts of a multimodal large model. A large model with a structure shown in FIG. 5 is used as an example. A bypass task network corresponding to the bridge network can be disposed on a bypass of one or more network layers of the bridge network. In addition, a corresponding bypass task network is disposed on a bypass of one or more network layers of the natural language processing network. Specifically, the large model includes an image encoder, a bridge network, and a natural language processing network; and the bridge network is connected between the image encoder and the natural language processing network, and is configured to convert an encoding result of the image encoder into text representation space. The target network layer can include a first target layer and a second target layer, the first target layer belongs to the bridge network, and the second target layer belongs to the natural language processing network. Correspondingly, the bypass task network includes a first task network disposed on a bypass of the first target layer and a second task network disposed on a bypass of the second target layer. The two bypass task networks are respectively configured to fine-tune a network layer in the bridge network and a network layer in the natural language processing network. A model architecture in this embodiment can be shown in FIG. 6.

In a further embodiment, a bypass task network can be disposed only in the natural language processing network part for a multimodal large model. In this case, a model architecture related to the bypass task network is similar to or degraded to the example in FIG. 4, and details are omitted here for simplicity.

In conclusion, in the multi-task large model training method provided in this embodiment of this specification, a task universal adapter and a task dedicated adapter are clearly distinguished, so that efficient multi-task fine-tuning can be implemented on the large language model even when computing resources are limited. The universal adapter and the dedicated adapter are separated, to effectively alleviate common seesaw and negative transfer problems in multi-task learning, thereby improving overall performance. In addition, the bypass task network provided in this specification can further learn of a clear task hierarchical structure based on a selected adapter, to deeply learn of a relationship between a task and an adapter required for effectively completing the task (namely, a value of weight corresponding to each adapter), and provide convincing interpretability.

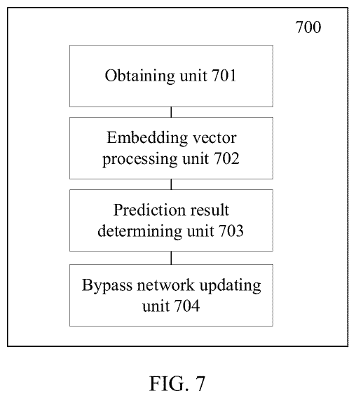

According to an embodiment in another aspect, a multi-task large model training apparatus is further provided. FIG. 7 is a schematic block diagram of a multi-task large model training apparatus according to an embodiment. A large model includes a trained target network layer and a to-be-trained bypass task network, the bypass task network includes several universal adapters and a plurality of dedicated adapters that respectively correspond to a plurality of preset task types, and has weight parameters corresponding to adapters. The apparatus can be deployed on any device, platform, or device cluster with a computing and processing capability. As shown in FIG. 7, the apparatus 700 includes:
an obtaining unit 701, configured to obtain a first embedding vector corresponding to a first sample, where the first sample includes at least one of image data and text data, and has a first task type, and the first task type belongs to the plurality of preset task types;
an embedding vector processing unit 702, configured to: separately input the first embedding vector into the target network layer to perform target processing, and input the first embedding vector into the bypass task network to perform bypass processing, where the bypass processing includes: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector;
a prediction result determining unit 703, configured to: determine an output vector based on the second embedding vector and a third embedding vector output through the target processing, and determine a prediction result based on the output vector; and
a bypass network updating unit 704, configured to update the bypass task network based on a loss corresponding to the prediction result.

According to an embodiment in another aspect, a computer-readable storage medium is further provided. The computer-readable storage medium stores a computer program. When the computer program is executed on a computer, the computer is enabled to perform the method described in any one of the above-mentioned embodiments.

According to an embodiment in still another aspect, a computing device is further provided, and includes a memory and a processor. The memory stores executable code. When the processor executes the executable code, the method described in any one of the above-mentioned embodiments is implemented.

The embodiments of this specification are described in a progressive way. For same or similar parts in the embodiments, references can be made to each other. Each embodiment focuses on a difference from another embodiment. Particularly, the apparatus embodiments are basically similar to the method embodiments, and therefore are described briefly. For related parts, references can be made to related descriptions in the method embodiments.

Specific embodiments of this specification are described above. Other embodiments fall within the scope of the appended claims. In some cases, the actions or steps described in the claims can be performed in an order different from that in the embodiments, and the desired results can still be achieved. In addition, the process depicted in the accompanying drawings does not necessarily need a particular order or consecutive order to achieve the desired results. In some implementations, multi-tasking and concurrent processing are feasible or may be advantageous.

It should be noted that in this specification, relationship terms such as first and second are merely used to distinguish an entity or operation from another entity or operation, and do not necessarily require or imply that there is any such actual relationship or sequence between these entities or operations. In addition, the term “include”, “comprise”, or any other variants thereof is intended to cover a non-exclusive inclusion, so that a process, a method, a product, or an apparatus that includes a series of elements not only includes those elements, but also includes other elements not expressly listed, or further includes elements inherent to such a process, method, product, or apparatus. Without more constraints, an element preceded by “includes a . . . ” does not preclude the presence of additional identical elements in the process, method, product, or apparatus that includes the element.

A person of ordinary skill in the art can understand that all or some of the steps in the embodiments can be completed by hardware, or can be completed by a program instructing related hardware. The program can be stored in a computer-readable storage medium. The storage medium can be a read-only memory, a magnetic disk, an optical disc, etc.

In the above-mentioned specific implementations, the objective, technical solutions, and beneficial effects of this specification are further described in detail. It should be understood that the above-mentioned descriptions are merely specific implementations of this specification, but are not intended to limit the protection scope of this specification. Any modification, equivalent replacement, improvement, etc. made without departing from the spirit and principle of this specification shall fall within the protection scope of this specification.

1. A multi-task large model training method, wherein a large model comprises a trained target network layer and a to-be-trained bypass task network, the bypass task network comprises several universal adapters and a plurality of dedicated adapters that respectively correspond to a plurality of preset task types, and has weight parameters corresponding to adapters, and the method comprises:
obtaining a first embedding vector corresponding to a first sample, wherein the first sample comprises at least one of image data and text data, and has a first task type, and the first task type belongs to the plurality of preset task types;
separately inputting the first embedding vector into the target network layer to perform target processing, and inputting the first embedding vector into the bypass task network to perform bypass processing, wherein the bypass processing comprises: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector;
determining an output vector based on the second embedding vector and a third embedding vector output through the target processing, and determining a prediction result based on the output vector; and
updating the bypass task network based on a loss corresponding to the prediction result.

2. The method according to claim 1, wherein upon determining that the first sample is image data, the task type comprises at least image classification, target detection, image segmentation, and image description; and
upon determining that the first sample is text data, the task type comprises at least text classification, named entity recognition, text summarization, text question answering, and text emotion recognition.

3. The method according to claim 1, wherein the first sample comprises image data and text data, and the plurality of preset task types are tasks associated with an image-text association.

4. The method according to claim 3, wherein the large model comprises an image encoder, a bridge network, and a natural language processing network; the bridge network is connected between the image encoder and the natural language processing network, and is configured to convert an encoding result of the image encoder into text representation space; the target network layer belongs to the bridge network; and the first embedding vector corresponds to the image data.

5. The method according to claim 3, wherein the large model comprises an image encoder, a bridge network, and a natural language processing network; the bridge network is connected between the image encoder and the natural language processing network, and is configured to convert an encoding result of the image encoder into text representation space; the target network layer comprises a first target layer and a second target layer; the bypass task network comprises a first task network as a bypass of the first target layer and a second task network as a bypass of the second target layer; the first target layer belongs to the bridge network; and the second target layer belongs to the natural language processing network.

6. The method according to claim 1, wherein the weight parameters comprises a first parameter matrix and a second parameter set, a quantity of rows and a quantity of columns of the first parameter matrix respectively correspond to a quantity of preset task types and a quantity of universal adapters, a first weight parameter at any location indicates a weight of a corresponding universal adapter in a corresponding task type, and the second parameter set comprises at least a second weight parameter corresponding to each of the plurality of dedicated adapters.

7. The method according to claim 6, wherein the dedicated adapter comprises a plurality of sub-adapters, and a second weight parameter corresponding to any dedicated adapter comprises a plurality of sub-weight parameters corresponding to the plurality of sub-adapters.

8. The method according to claim 6, wherein performing weighted summation on processing results of the adapters based on the weight parameters, to obtain a second embedding vector comprises:
obtaining a first weight parameter of each universal adapter in the first task type from the first parameter matrix, and obtaining a second weight parameter corresponding to the first dedicated adapter from the second parameter set; and
performing weighted summation on each first result of performing the first embedding vector by each universal adapter and a second result of processing the first embedding vector by the first dedicated adapter, to obtain the second embedding vector, wherein a weight factor of each first result is determined based on the first weight parameter, and a weight factor of the second result is determined based on the second weight parameter.

9. The method according to claim 8, wherein the weight factor of each first result is determined in the following method:
inputting the first weight parameter of each universal adapter in the first task type in the first parameter matrix into a Gumbel-Sigmoid function, and inputting an output result into a softmax layer, to obtain the weight factor of each first result.

10. The method according to claim 1, wherein the adapters comprise at least one of the following: a LoRA adapter, an AdaLoRA adapter, and an (IA) 3 adapter.

11. The method according to claim 1, wherein the large model is a model based on a transformer architecture, and the target network layer is one of the following: a query layer, a key layer, a value layer, an output layer, and an MLP layer.

12. (canceled)

13. A non-transitory computer-readable storage medium comprising instructions stored therein that, when executed by a processor of a computing device, causes the computing device to implement a multi-task large model training method, wherein a large model comprises a trained target network layer and a to-be-trained bypass task network, the bypass task network comprises several universal adapters and a plurality of dedicated adapters that respectively correspond to a plurality of preset task types, and has weight parameters corresponding to adapters, and the method comprises:
obtaining a first embedding vector corresponding to a first sample, wherein the first sample comprises at least one of image data and text data, and has a first task type, and the first task type belongs to the plurality of preset task types;
separately inputting the first embedding vector into the target network layer to perform target processing, and inputting the first embedding vector into the bypass task network to perform bypass processing, wherein the bypass processing comprises: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector;
determining an output vector based on the second embedding vector and a third embedding vector output through the target processing, and determining a prediction result based on the output vector; and
updating the bypass task network based on a loss corresponding to the prediction result.

14. A computing device, comprising a memory and a processor, wherein the memory stores executable instructions that, in response to execution by the processor, causes the computing device to implement a multi-task large model training method, wherein a large model comprises a trained target network layer and a to-be-trained bypass task network, the bypass task network comprises several universal adapters and a plurality of dedicated adapters that respectively correspond to a plurality of preset task types, and has weight parameters corresponding to adapters, and the method comprises:
obtaining a first embedding vector corresponding to a first sample, wherein the first sample comprises at least one of image data and text data, and has a first task type, and the first task type belongs to the plurality of preset task types;
separately inputting the first embedding vector into the target network layer to perform target processing, and inputting the first embedding vector into the bypass task network to perform bypass processing, wherein the bypass processing comprises: separately processing the first embedding vector by using the several universal adapters and a first dedicated adapter in the plurality of dedicated adapters that corresponds to the first task type, and performing weighted summation on processing results of the adapters based on the weight parameters, to obtain a second embedding vector;
determining an output vector based on the second embedding vector and a third embedding vector output through the target processing, and determining a prediction result based on the output vector; and
updating the bypass task network based on a loss corresponding to the prediction result.

15. The computing device according to claim 14, wherein upon determining that the first sample is image data, the task type comprises at least image classification, target detection, image segmentation, and image description; and
upon determining that the first sample is text data, the task type comprises at least text classification, named entity recognition, text summarization, text question answering, and text emotion recognition.

16. The computing device according to claim 14, wherein the first sample comprises image data and text data, and the plurality of preset task types are tasks associated with an image-text association.

17. The computing device according to claim 16, wherein the large model comprises an image encoder, a bridge network, and a natural language processing network; the bridge network is connected between the image encoder and the natural language processing network, and is configured to convert an encoding result of the image encoder into text representation space; the target network layer belongs to the bridge network; and the first embedding vector corresponds to the image data.

18. The computing device according to claim 16, wherein the large model comprises an image encoder, a bridge network, and a natural language processing network; the bridge network is connected between the image encoder and the natural language processing network, and is configured to convert an encoding result of the image encoder into text representation space; the target network layer comprises a first target layer and a second target layer; the bypass task network comprises a first task network as a bypass of the first target layer and a second task network as a bypass of the second target layer; the first target layer belongs to the bridge network; and the second target layer belongs to the natural language processing network.

19. The computing device according to claim 14, wherein the weight parameters comprises a first parameter matrix and a second parameter set, a quantity of rows and a quantity of columns of the first parameter matrix respectively correspond to a quantity of preset task types and a quantity of universal adapters, a first weight parameter at any location indicates a weight of a corresponding universal adapter in a corresponding task type, and the second parameter set comprises at least a second weight parameter corresponding to each of the plurality of dedicated adapters.

20. The computing device according to claim 19, wherein the dedicated adapter comprises a plurality of sub-adapters, and a second weight parameter corresponding to any dedicated adapter comprises a plurality of sub-weight parameters corresponding to the plurality of sub-adapters.

21. The computing device according to claim 19, wherein performing weighted summation on processing results of the adapters based on the weight parameters, to obtain a second embedding vector comprises:
obtaining a first weight parameter of each universal adapter in the first task type from the first parameter matrix, and obtaining a second weight parameter corresponding to the first dedicated adapter from the second parameter set; and
performing weighted summation on each first result of performing the first embedding vector by each universal adapter and a second result of processing the first embedding vector by the first dedicated adapter, to obtain the second embedding vector, wherein a weight factor of each first result is determined based on the first weight parameter, and a weight factor of the second result is determined based on the second weight parameter.
